(19) United States
(12) Patent Application Publication
(10) Pub. No.: US 2005/0275291 A1
(43) Pub. Date: Dec. 15, 2005

(54) Mechanical switch series to activate/deactivate an electrical appliance

(76) Inventor: Wen-Lung Tsai, Taoyuan City (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/865,811

(22) Filed: Jun. 14, 2004

(51) Int. Cl. H02B 1/24

(52) U.S. Cl. 307/114

(57) ABSTRACT

A mechanical switch includes a housing. A substantially X-shaped conducting plate is received in the housing and provided with a first terminal pair and a second terminal pair mounted on the conducting plate. Two blades each are engaged with a corresponding one of the first and second terminal pairs. A pushbutton is pivotally mounted on top of the housing with two springs extending from the bottom of the housing to respectively engage with a corresponding one of the two blades to allow the two blades to change engagement with terminals in each of the first and second terminal pairs such that an electrical appliance is controlled.

### BACKGROUND OF THE INVENTION

1.Field of the Invention

The present invention relates to a mechanical switch series, and more particularly to a mechanical switch series to activate or deactivate the same electrical appliance.

2. Description of Related Art

A conventional mechanical switch is shown in FIG. 1. The switch has two gates A1 and A2 and two parallel wires connecting the two gates A1 and A2. Inside the switch, two blades C1 and C2 are pivotally mounted to respectively connect to contacts a1 and b2 or to a2 and b2 such that an electrical appliance E is able to be activated or deactivated. This kind of switch only allows the operator to activate/deactivate the electrical appliance at two different positions, namely a position where the blade C1 is located and a position where the blade C2 is located. Therefore, if an operator tries to activate a stair light which is three rooms away from the operator, the operator has to walk in the dark to the nearest switch to control the stair light activation, which is quite dangerous and inconvenient.

To overcome the shortcomings, the present invention intends to provide an improved mechanical switch series to mitigate or obviate the aforementioned problems.

### SUMMARY OF THE INVENTION

The primary objective of the invention is to provide an improved mechanical switch series having multiple switches to control the same electrical appliance.

Other objects, advantages and novel features of the invention will become more apparent from the following detailed description when taken in conjunction with the accompanying drawings.

### BRIEF DESCRIPTION OF THE DRAWINGS

FIG. 1 is a schematic diagram showing the theory of a conventional mechanical switch;

FIG. 2 is a schematic diagram showing the theory of the switch of the present invention;

FIG. 3 is a schematic diagram showing the theory of a different embodiment of the switch of the present invention;

FIG. 4 a partially exploded perspective view of the switch based on the theory of FIG. 3 of the present invention;

FIG. 5 is a fully exploded perspective view of the switch based on the theory of FIG. 3 of the present invention;

FIG. 6 is a cross-sectional view showing the switch of the present invention; and

FIG. 7 is a top view of the switch of the present invention.

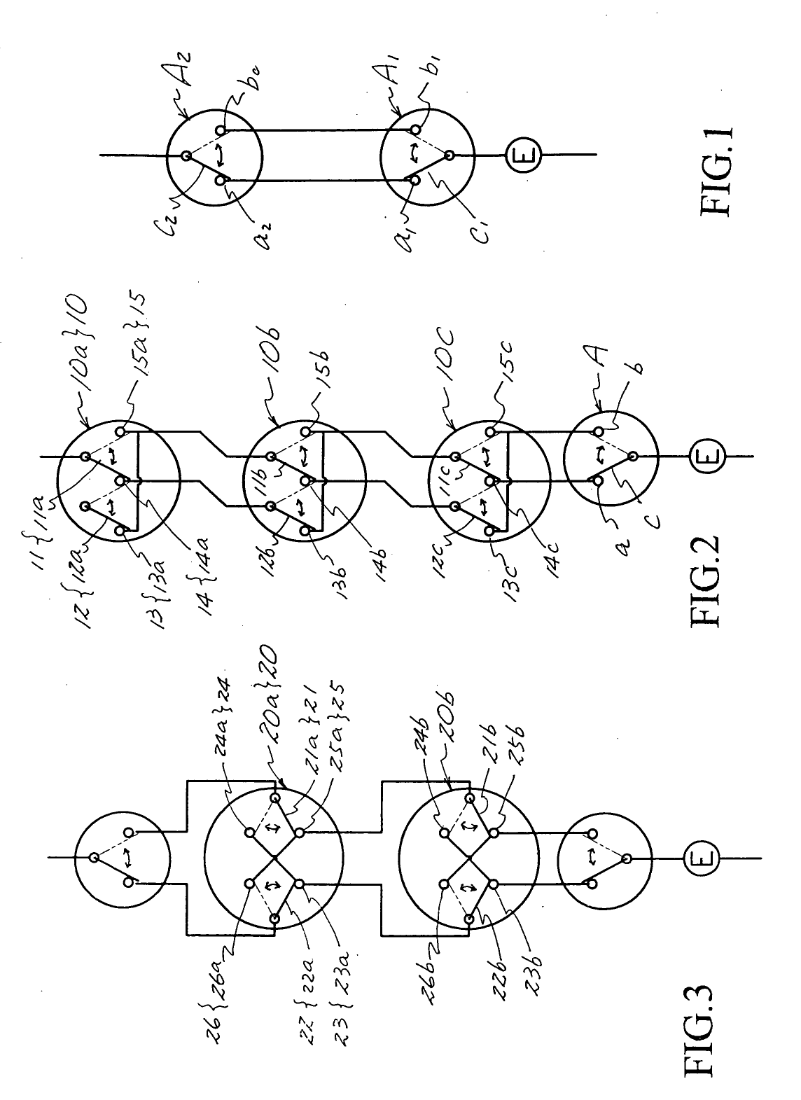

### DETAILED DESCRIPTION OF PREFERRED EMBODIMENT

With reference to FIG. 2, a schematic circuit diagram showing the theory of the switch series of the present invention is shown and has multiple switches 10 (1Oa, 10b, and 10c) provided with control knots on the circuit of the present invention. Each control knot is able to control the opening and closing of the circuit. The switch on both ends of the circuit may be the same as any one of the switches 10a, 10b, or 10c or a single switch on-off switch A. The switches in between have to be the same as any one of the switches 1Oa, 10b, or 10c so as to control the activation or deactivation of the electrical appliance E. The circuit in FIG. 2 is a closed circuit (the electrical appliance E is activated). If a first blade 11a of the switch 10a on top of the circuit is pivoted to contact the terminal 15a (a second blade 12a is pivoted to contact the terminal 14a), the electrical appliance E is deactivated. Under the same circumstance, if a third blade set 11b and 12b of the switch 10b is pivoted to contact terminals 14b and 15b from terminals 13b and 14b, the circuit is open again. Again, under the same circumstance, if a fourth blade set 11c and 12c of the switch 10c is pivoted to contact terminals 14c and 15c from terminals 13c and 14c, the circuit is closed. Therefore, numerous control knots may be provided on the circuit to control the same electrical appliance.

The theory of the present invention may also include the structure shown in FIG. 2. Each switch has two blades (11 and 12) and three terminals (13, 14, and 15). FIG. 3 shows a different switch including two blades (21 and 22), and four terminals (23, 24, 25, and 26). It is noted that the operator is able to change the blades (21a and 22a) and terminals (24a and 26a) of the switch (20a) to terminals (25a and 23a) such that the circuit is changed from a closed state to an open state. Under the same state (the open state), the operator is able to operate the next switch (20b) to change the blades' (21b and 22b) terminals (24b and 26b) to terminals (25b and 23b) such that the circuit is changed from the open state to the closed state.

Within the terminals (23, 24, 25, and 26), the terminals (23 and 24) communicate with each other and terminals (25 and 26) communicate with one another. Therefore, the operator is able to change the blade position along the circuit to control the activation of the electrical appliance.

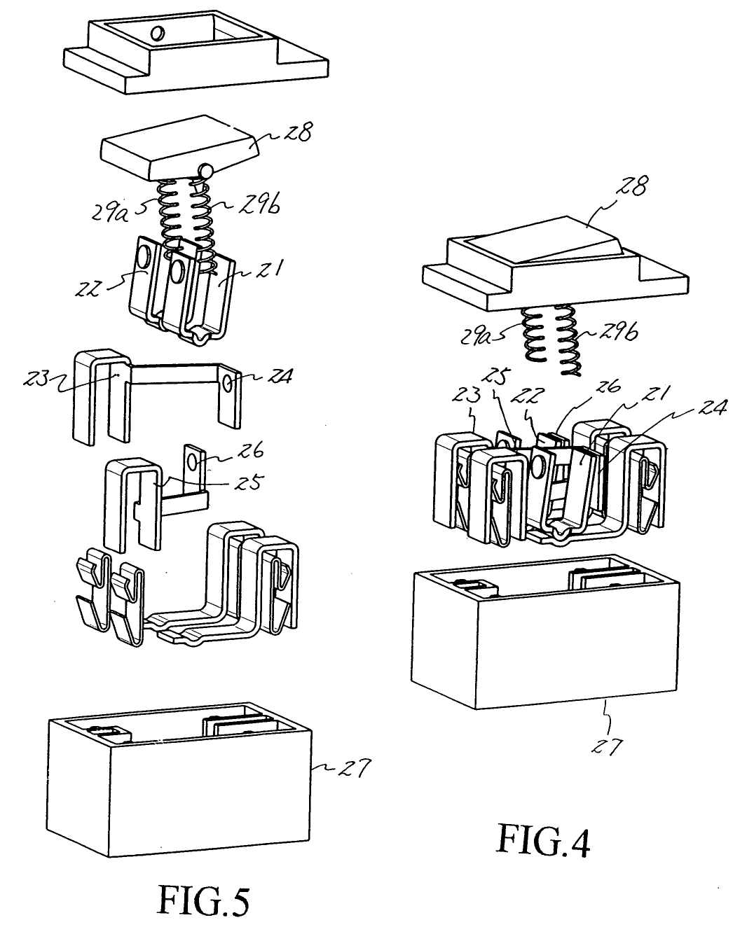

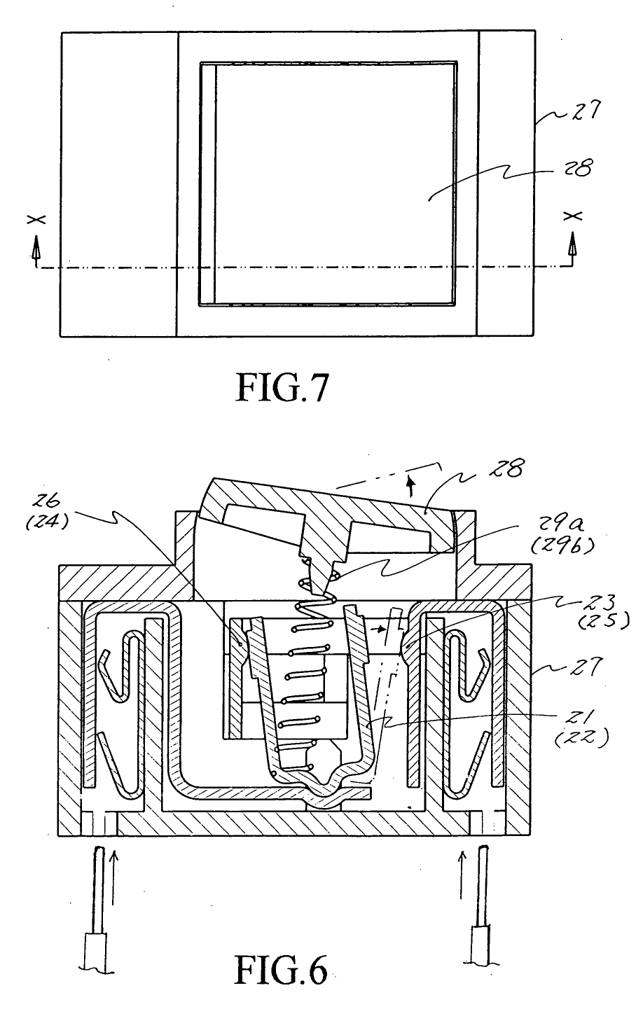

The structure using the theory in FIG. 3 is shown in FIGS. 4 and 5. The switch (20) has a housing (27), a substantially X-shaped terminal conducting plate received in the housing (27) and provided with terminals (23 and 26; and 24 and 25) mounted on the X-shaped terminal conducting plate, two blades (21 and 22) each pivotally connected to one set of terminals (23 and 26; 24 and 25) and a pushbutton (28) with two springs (29a and 29b) extending from the bottom of the pushbutton (28) to respectively engage with one of the two corresponding blades (21 and 22) so as to allow the blades (21 and 22) to contact the terminal set (23 and 26; 24 and 25). Therefore, it is noted that when the pushbutton (28) is pivoted, the two blades (21 and 22) are able to change engagement with the terminals (23 and 26; 24 and 25), as shown in FIGS. 6 and 7.

Referring to FIG. 5, it is noted that the terminals (23 and 24) are mounted on the same conducting plate and terminals (24 and 25) are mounted on a different conducting plate such that when multiple switches of the present invention are connected in series, the operator is able to use any one of the switches on the circuit to control the activation of the same electrical appliance.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A mechanical switch series to activate/deactivate an electrical appliance, the mechanical switch series having multiple switches each having two input terminals and two output terminals, the input terminals interoperably connected to a pair of blades and the output terminals interoperably connected to two conductors respectively, each conductor having a front contact point formed on a front portion of the conductor and a rear contact point formed on a rear portion of the conductor, the two conductors being located crosswise with the front contact points located diagonally across from the rear contact points with respect to each of the two blades, such that movement of the blades causes them to engage with contact points on the same side of the blade.

2. The mechanical switch series as claimed in claim 1, wherein each conductor has three contact points and the two blades are sandwiched between two adjacent contact points so that the movement of the blades is able to change the circuit of the switch.

3. A mechanical switch comprising:
a housing;
a substantially X-shaped conducting plate received in the housing and provided with a first terminal pair and a second terminal pair mounted on the conducting plate;
two blades each engaged with a corresponding one of the first and second terminal pairs; and
a pushbutton pivotally mounted on top of the housing and having two springs extending from the bottom of the housing to respectively engage with a corresponding one of the two blades to allow the two blades to change engagement with terminals in each of the first and second terminal pairs such that an electrical appliance is controlled.
